(19) United States
(12) Patent Application Publication
(10) Pub. No.: US 2013/0211642 A1
(43) Pub. Date: Aug. 15, 2013

(54) METHOD FOR OPERATING AN ELECTRIC BATTERY OF A MOTOR VEHICLE, AND MOTOR VEHICLE VERFAHREN ZUM BETREIBEN EINER ELEKTRISCHEN BATTERIE EINES KRAFTFAHRZEUGS SOWIE KRAFTFAHRZEUG

(71) Applicants: Boris Blasinski, Ingolstadt (DE); Rene Kasteneder, Munchsmunster (DE)

(72) Inventors: Boris Blasinski, Ingolstadt (DE); Rene Kasteneder, Munchsmunster (DE)

(73) Assignee: AUDI AG, Ingolstadt (DE)

(21) Appl. No.: 13/700,642

(22) PCT Filed: May 12, 2011
(86) PCT No.: PCT/EP2011/002059

§ 371 Date: Jan. 16, 2013

(30) Foreign Application Priority Data
May 29, 2010 (DE) 10 2010 022 021.3

(51) Int. Cl. B60W 20/00; H02J 7/00

(52) U.S. Cl. CPC B60W 20/00; H02J 7/0068; Y10S 903/903
USPC 701/22; 320/128; 320/134; 180/65.29; 903/903

(57) ABSTRACT

An electric battery of a hybrid vehicle can be heated by alternately discharging and charging the battery during a cold start, wherein the battery initially does not supply power to drive the vehicle. Heating the battery can also be used to simultaneously change the charge state of the battery. The heating can be started immediately at the cold start, without the need to first bring the electric battery to a specific charge state.

The invention relates to a method according to the preamble of claim 1 and to a motor vehicle according to the preamble of claim 7.

The starting point is a situation wherein in a hybrid vehicle, i.e. a motor vehicle with an internal combustion engine and an electric drive, a battery supplying electric current for the electric drive is too cold. It is known to then heat the battery. Heating is performed by partially discharging and partially recharging the battery in an alternating sequence. In this mode of operation, when beginning to drive, the internal combustion engine initially operates, whereas the electric drive operates with the reverse operating principle, namely as a generator. The generator produces current pulses which are supplied to the battery, whereby heat is generated due to the resistance of the battery. The battery is alternately discharged and charged by alternatingly applying a positive and a negative torque to the electric machine. The changing load of the electrical machine is compensated by the internal combustion engine so that a torque desired by the driver is applied to the wheels when the motor vehicle is moving.

To prevent the discharging and partial charging process from affecting the life of the battery, the charge state of the battery at each partial discharging and partial charging operation is changed only by maximally 1% of the maximum charge (the so-called absolute SOC, “state of charge”), optionally by 2%

Heating an electric battery in this manner is known, for example, from JP 2005 332 777 A, JP 2007 012 568 A and U.S. Pat. No. 7,015,676 B2.

As described for example in U.S. Pat. No. 7,015,676 B2, the partial discharging operation and the partial charging operation occur at a certain charge state of the battery, meaning in a certain interval for the SOC. For example, this interval is between 70% and 80% SOC.

For example, the battery may have an SOC of 30% at a cold start. Up to now, the charge state of the battery was therefore required to fall inside the aforementioned interval. The battery is thus first charged without being heated, with heating beginning only after the interval has been reached.

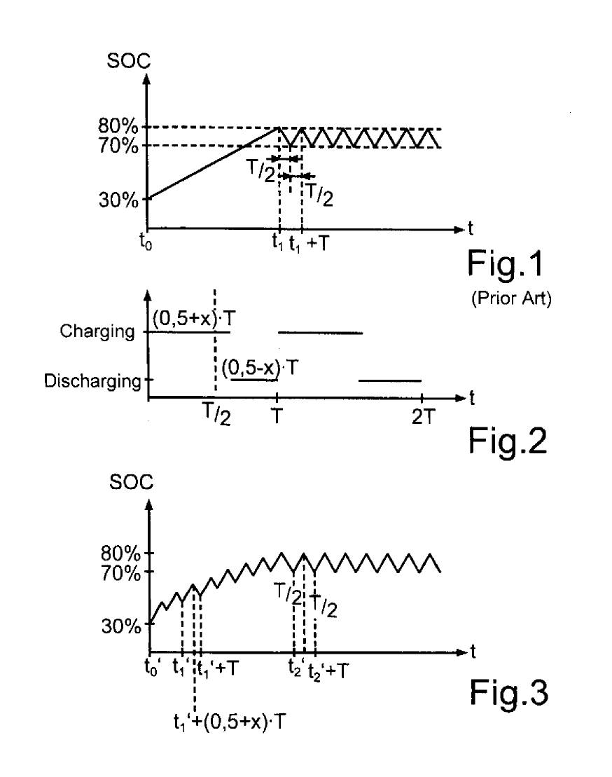

This will now be explained with reference to FIG. 1, which illustrates the charge state as a function of time for an example according to the prior art.

It will be assumed that the charge state SOC of the electrical battery at a cold start at a time t₀ is 30%. The motor vehicle is being driven by the internal combustion engine, while the generator is operated at the same time, with the generated electricity being used to charge the battery, until the charge state SOC is in an interval between 70% and 80% at a time t₁. Once this interval has been reached, heating of the battery begins by alternatingly discharging and recharging the battery. The current pulses for discharging the battery and the current pulses for charging the battery have the same magnitude and occur periodically with a time period T, with the discharging operation taking place during the first half of the period and having a duration T/2, and with the charging operation takes place in the second half and having the same duration T/2. Thus, once heating has begun, no permanent changes of the charge state of the electric battery occur aside from the periodic variation.

Disadvantageously, charging the battery, in the example between the time duration t₀ and the time duration t₁, or in other situations discharging the battery with the prior art method takes an excessive amount of time, during which the battery is not heated. This delays the subsequent use of the battery, and more particularly, the electrical drive can be operated only with a delay when the battery is initially cold.

It is an object of the invention, to provide an approach for using the electric drive in a hybrid vehicle in a better way, especially at least more conveniently, or at least more efficiently.

The object is attained, in one aspect, with a method having the features according to claim 1, and in another aspect with a motor vehicle having the features according to claim 7.

According to the invention, a permanent change in the charge state is effected by performing a plurality of repetitions of the first and second operation (partial discharging and partial charging).

In other words, the alternating sequence of partial discharging and partial charging has no longer a neutral effect on the charge state, and the heating process is instead simultaneously used to effect a change in the charge state.

A permanent change in this context refers in particular to a change in the charge state of the battery that extends over several time periods. In particular, the charge state of the battery during the individual partial discharging and partial charging operations is changed only by at most 2%, preferably even only by between 0.8% and 1.5%, for example by 1%. The permanent change preferably exceeds this percentage change. The change occurring after several time periods is thus preferably greater than the change caused by partial discharging or partial charging during an operation within a single period.

Preferably, each operation has a duration of at most one minute, particularly preferred even only at most 20 seconds, more preferably between 5 and 15 seconds, for example 10 seconds; with the invention, a particularly small period duration is thus selected, making the heating process very efficient.

As known from the prior art, the repetition is preferably periodic. However, unlike in the prior art, the two operations (partial discharging and partial charging) have unequal durations during the time period. If a permanent charge is to be supplied, then the partial charging operation takes longer than the partial discharging operation. If a permanent discharge is to be applied, then the operation of partial discharging takes longer than that of partial charging. With suitable timing of the partial discharging and partial charging operations, prior art techniques may be used in all other aspects, wherein the partial discharging and the partial charging operations always proceed with identical speed.

Alternatively, a permanent change in the charge state may also be attained when the partial discharging and the partial charging operations have the same duration, but the currents have different amplitudes, for example, when for causing a permanent increase in the charge, a larger current is supplied to the battery than is drained from the battery during the partial discharging operation.

With the method according to the invention, heating of the battery and the process according to the invention can be immediately begun at a cold start of the motor vehicle, i.e., there is no longer a requirement to wait until the charge state of the electric battery is within a certain interval of values. A characteristic feature of a cold start is that the temperature, in particular the temperature of the electrical battery itself, is below a predetermined value.

The permanent change of the charge state will typically be a positive change, i.e. the battery will usually be permanently charged, causing the charge stored in the battery to increase. With the invention, the charging operation is linked in an efficient way with heating the battery. The battery is at the same time charged relatively rapidly and is at the same also heated relatively quickly, so that the electric machine can be operated as a drive within a very short time.

The motor vehicle according to the invention includes an internal combustion engine and an electric drive, with which an electric battery is associated for supplying power; in addition, the motor vehicle includes a control device which is configured to cause the battery to be periodically alternatingly discharged and charged, wherein the motor vehicle is characterized in that the control device is configured to cause the periodic discharging and charging, such that a change in the charge state of the battery is attained over several time periods. In particular, the control device enables timing of the discharging and charging operations so that the respective operations have different durations, i.e. they take up different proportions of the duration of a time period. To increase the variability, the duration of a period may also be variable and may be changed during the heating process.

A preferred embodiment of the invention will now be described with reference to the drawing, in which

FIG. 1 shows an exemplary curve of the charge state of an electrical battery as a function of time according to the prior art,

FIG. 2 illustrates schematically a sequence of charging and discharging operations according to the present invention, and

FIG. 3 shows an exemplary curve of the charge state of the battery as a function of time similar to FIG. 1, however according to the present invention.

To illustrate the invention, it will again be assumed that the battery has a charge state of 30% at a time t₀′, and that the battery is cold and needs to be heated. Unlike in the prior art (see FIG. 1), heating starts immediately at the time t₀′. It begins by charging and discharging the electric battery in an alternating sequence. At the same time heating takes place, the battery is first charged from 30% to the interval of between 70% and 80%. This is accomplished by making the charging operation slightly longer than the discharging operation while the current pulses have the same magnitude. When the charging and discharging operations take place in a single period having a total duration T, the charging operation lasts a little longer than the time period T/2, namely for a time period of (0.5+x)·T, wherein 0<x<0.5, preferably 0.05<x<0.45. Correspondingly, the discharging operation takes place over a time period of (0.5−x)·T.

As is apparent from FIG. 3, the charge state SOC increases from a time to a time t₁′+T during the time period T, i.e. the battery is on the whole charged slightly more than discharged during each time period.

The reason is that charging takes place until the time period of t₁′+(0.5+x)·T, whereas discharging takes place during a shorter remaining time.

The operation of net charging the battery is performed up to a time t₂′. In addition, the period may be varied within the time period between t₀′ and t₂′. Heating takes place from the time t₂′ in a conventional manner such that the time duration of the charging and discharging operation is always equal to T/2, so that the charge state no longer permanently changes after reaching a desired charge state at the time t₂′.

After the heating process is terminated, the battery can then be used to supply electric current to the electric drive of the vehicle. The battery is then discharged again, which is not shown in FIG. 3.

Any curve shape of the charge state over time can be attained through suitable selection of the parameters x and T, both of which can be varied during the heating process. Depending on the characteristics of the electrical battery, the temperature and possibly additional parameters, a respective appropriate curve can be followed during the heating and the simultaneous charging operation.

The same approach applies in a situation where the battery must first be discharged at a cold start.

What is claimed is:

1.-7. (canceled)

8. A method for operating an electric battery of a motor vehicle, comprising:
partially discharging the battery in a first operation and is thereafter partially charging the battery in a second operation so as to cause heating of the battery, said first and second operation having a combined duration defining a time period, and
repeating the first operation and the subsequent second operation several times so as to change a charge state of the battery after several time periods.

9. The method of claim 8, wherein the charge state of the battery is changed by at most 2% during any one of the first and second operations.

10. The method of claim 8, wherein each of the first and second operations has a duration of not more than one minute.

11. The method of claim 8, wherein each of the first and second operations has a duration of at most 20 seconds.

12. The method of claim 8, wherein each of the first and second operations has a duration between 5 and 15 seconds.

13. The method of claim 8, wherein the first and the subsequent second operation are repeated periodically at least a predetermined number of times, wherein a first partial duration of the first operation is different from a second partial duration of the second operation and a sum of the first and second partial durations is equal to the time period.

14. The method of claim 13, wherein the first and second partial durations are varied from one time period to another time period.

15. The method of claim 8, wherein the method is performed immediately at a cold start of the motor vehicle.

16. The method of claim 8, wherein changing the charge state of the battery comprises increasing a charge stored in the battery.

17. A motor vehicle, comprising:
an internal combustion engine,
an electric drive,
an electric battery assigned to the electric drive for supplying electric power to the electric drive, and
a control device which is configured to
repeatedly partially discharge the battery in a first operation and subsequently partially charge the battery in a second operation for heating the battery, said first and second operation having a combined duration defining a time period, and to
repeat the first and subsequent second operation several times such that a charge state of the battery is changed after several time periods.
